(19) United States
(12) Patent Application Publication
(10) Pub. No.: US 2019/0174252 A1
(43) Pub. Date: Jun. 6, 2019

(54) Method and Apparatus for Wireless Client-to-Network Host Association

(71) Applicant: Rapid Focus Security, LLC, Burlington, VT (US)

(72) Inventors: Ellery Crane, South Burlington, VT (US); Richard Daniel Farina, Moon Township, PA (US)

(73) Assignee: Rapid Focus Security, LLC, Burlington, VT (US)

(21) Appl. No.: 15/834,020

(22) Filed: Dec. 6, 2017

(51) Int. Cl. H04W 4/00; H04L 12/24; H04L 29/08

(52) U.S. Cl. CPC H04W 4/005; H04L 67/12; H04L 41/12

(57) ABSTRACT

A wireless device association apparatus includes a sensor having a wireless traffic analyzer that is configured to detect a wireless signal from a first wireless device. A wireless interface is configured to send a first fingerprinted data sequence to the first wireless device and is configured to detect a second fingerprinted data sequence received at a second wireless device. A processor is configured to correlate a first signature derived from the first fingerprinted data sequence and the second signature derived from the second fingerprinted data sequence to determine an association between the first and second devices.

The section headings used herein are for organizational purposes only and should not be construed as limiting the subject matter described in the present application in any way.

### INTRODUCTION

The growing number of wireless and wired network devices worldwide has generated a need for methods and apparatus that provide accurate identification and tracking information about these devices quickly and efficiently. With the advent of 4th Industrial Revolution and a world predicted to be networked by nearly thirty billion connected devices by 2025, with a significant majority of them connecting to the Internet and/or private networks using a variety of wireless protocols, accurately establishing the identity of such a device in the context of the network in an efficient manner is of fundamental importance for ensuring the monitoring and management of the known devices as well as protecting the network from intruding devices.

From a security and compliance perspective, a well-monitored environment or ecosystem of wireless devices will require fast and accurate identification of intruding devices and also the subsequent isolation of those devices. Identification schemes must act quickly enough to be able to nullify a threat in a timely manner. Identification schemes also benefit from the ability to track the movement of intruding devices accurately and consistently and to accurately pinpoint the physical device that is associated with a specific wireless signal.

### BRIEF DESCRIPTION OF THE DRAWINGS

The present teaching, in accordance with preferred and exemplary embodiments, together with further advantages thereof, is more particularly described in the following detailed description, taken in conjunction with the accompanying drawings. The skilled person in the art will understand that the drawings, described below, are for illustration purposes only. The drawings are not necessarily to scale, emphasis instead generally being placed upon illustrating principles of the teaching. The drawings are not intended to limit the scope of the Applicant's teaching in any way.

FIG. 1 illustrates a block diagram of an embodiment of a method and apparatus that associates a wireless client to a network host according to the present teaching.

FIG. 2 illustrates a process flow diagram of an embodiment of a method and apparatus for client/host association according to the present teaching.

FIG. 3A illustrates a steady state topology of a monitored network in which all known devices have been unequivocally associated with their network host identity according to the present teaching.

FIG. 3B illustrates a topology of the monitored network described in connection with FIG. 3A when a new, unassociated client and host enter the monitored network.

FIG. 3C illustrates a topology of the monitored network described in connection with FIG. 3A with the client and host association complete.

FIG. 4 illustrates a sequence diagram of an embodiment of a method and apparatus for wireless client-to-wireless host association according to the present teaching.

### DESCRIPTION OF VARIOUS EMBODIMENTS

The present teaching will now be described in more detail with reference to exemplary embodiments thereof as shown in the accompanying drawings. While the present teachings are described in conjunction with various embodiments and examples, it is not intended that the present teachings be limited to such embodiments. On the contrary, the present teachings encompass various alternatives, modifications and equivalents, as will be appreciated by those of skill in the art. Those of ordinary skill in the art having access to the teaching herein will recognize additional implementations, modifications, and embodiments, as well as other fields of use, which are within the scope of the present disclosure as described herein.

Reference in the specification to “one embodiment” or “an embodiment” means that a particular feature, structure, or characteristic described in connection with the embodiment is included in at least one embodiment of the teaching. The appearances of the phrase “in one embodiment” in various places in the specification are not necessarily all referring to the same embodiment.

It should be understood that the individual steps of the methods of the present teaching can be performed in any order and/or simultaneously as long as the teaching remains operable. Furthermore, it should be understood that the apparatus and methods of the present teachings can include any number or all of the described embodiments as long as the teaching remains operable.

One feature of the present teaching is the ability to associate general wireless client devices with wireless hosts. Clients connecting wirelessly to access points can be uniquely identified by their MAC addresses. Network hosts found on a network can be uniquely identified by a combination of MAC, IP address, hostname, and other criteria. There is currently no practical way to reliably know that a particular wireless client is the same device as a particular network host. More specifically, there is currently no practical way to reliably know that a particular wireless client is the same device as a particular network host, because typically MAC addresses reported by the wireless access points and the networking system are different. One example is a wireless device with dual network interfaces, where one is used to connect to the nearest wireless access point and the other is to connect to the wired network. The method and apparatus of the present teaching provides a means to actively correlate the identities of at least some of the wireless clients with the network hosts that are part of the same physical device.

One aspect of the present teaching is to provide improved correlation of multiple assets having multiple types across multiple sensors with a single physical device that is being observed. Such an improved correlation allows customers to better understand and monitor their networks. In particular, wireless signals emanating from a client device can appear to be from a different device than an identified wireless host device when, in fact, the client and host are the same device. This results in more apparent devices being tracked and/or monitored in a network than necessary. When wireless clients are accurately associated with hosts, fewer devices need to be tracked and monitored. Threats caused by (or against) the same physical device can be presented in a unified way allowing the generation of additional alerts to assist in awareness and remediation.

Methods of the present teaching enhance the ability to associate clients with hosts at scale. For example, an internet of things (IoT) environment includes a very large number of wireless devices that can connect using non-traditional wireless communication protocols. As such, environmental stress security systems that attempt to continuously uniquely identify and assess the wireless devices in a network can, for example, discover, inventory and classify some or all wireless devices in a network. The uniquely identified devices can then be monitored to determine behaviors and system relationships that represent threats or risks to any business critical or other information systems operating. Such security systems help ensure safety and compliance of critical information technology infrastructure. The ability to associate hosts and clients of the present teaching can improve the speed and accuracy of these security systems. In some embodiments, the apparatus and methods of the present teaching can enhance the capabilities of the Pulse™ network security platform product manufactured by Pwnie Express, Boston, Mass., the assignee of the present application.

A wireless network typically includes wireless devices, access points, and a larger network infrastructure that includes wireless and wired connections. The wireless devices may be mobile or stationary. The access points may include cell towers and various other types of known wireless access points. An access point may also be referred to as a base station. The wireless devices connect to access points, and to each other, using wireless links. A variety of known link protocols can be used.

A host device is a computer or other device that communicates with other hosts on a network. The host device can be stationary or mobile. Wireless host devices may be laptops, tablets, computers, smart phones, home appliances, personal wearables, and medical devices. The host device executes various software applications. Hosts on a network may include clients and servers that send or receive data, services or applications.

The access points are typically connected to a larger network infrastructure via wired and/or wireless connections. The larger network infrastructure can at least in part form a cloud network that can support remote software services. This larger network infrastructure can be public, private or hybrid and can be on premise or at a remote location. Some network configurations, sometimes referred to as ad-hoc networks in the art, do not rely upon an access point to connect the wireless devices to the network infrastructure. Instead a direct link is established between one or more wireless device and a network infrastructure where the wireless devices are connected to each other. Those skilled in the art will appreciate that the method and apparatus of the present teaching apply to ad-hoc networks as well as traditional wired/wireless network infrastructures and other specialized wireless network architectures.

In some wireless network embodiments, an access point communicates with the wireless devices by periodically sending an identifier, such as a service set identifier (SSID) and/or media access control (MAC) address. The wireless host listens for these identifiers, requests an association with a particular access point, and initiates an association with a response from the access point. The wireless host may make a different association with another access point, for example, as the host moves to a different location.

On a TCP/IP network, each host has a host number that, together with a network identity, forms its own unique IP address. The host numbers are provided by a network host addressing and managing system. This network host addressing and managing system may reside in the wireless access point, or may be separate and reside in the larger, wired, network infrastructure. It is well known by those skilled in the art that a mobile wireless host may or may not need to change the IP address during a switch between access points depending upon whether the access points are within a common IP subnet or not.

One feature of the present teaching is the ability to quickly and accurately associate large numbers of wireless hosts and clients. Prior approaches to correlate wireless clients and network hosts have relied upon both assets sharing the same MAC address. This is effective for some client/host associations, but in many cases the wireless communication interface will use a different MAC address than the wired one, and therefore, simple MAC address matching will be insufficient. For example, dual homing devices have a wireless interface that uses a different MAC than the wired connection. In contrast, the method and apparatus of the present teaching ignores specific metadata discoverable on either network host or wireless client and instead forms the correlation by observing which wireless client receives the unique packets sent to a particular network host. While some prior art approaches primarily consider correlation based on asset metadata, the method and apparatus of the present teaching use their own collected data signature to identify the correlation, thereby increasing accuracy and resulting in a mechanism that is highly time efficient in building an accurate holistic topology of the entire environment incorporating wired and wireless devices.

For example, in a system relying on static metadata to determine association, a network host (typically identified by a combination of static and variable attributes: MAC address, IP address, hostname) is equated with a wireless device based purely on correlating the static metadata, such as the MAC address of the device. Such a correlation mechanism is often inadequate and inaccurate. For example, a physical device with dual network interfaces where one is used to connect to the nearest wireless access point and the other is used to connect to the wired network will be difficult to correlate because each network interface has its own unique MAC address. Also, the fact that the source MAC address can be forged in a network packet causes any type of static MAC based association to fail to ascertain with a sufficient degree of accuracy across an ecosystem of devices that these two different entities are actually the same physical device. Consequently, essential monitoring and management policies and actions around security, containment, device performance, and potential intrusion fail to be applied in a consistent manner. Another consequence of this lack of systemic awareness around device identity is an incomplete understanding of the entire network topology and identifying untrusted devices that are connected to the virtual network. The result is compromised wired and wireless segments of the network.

Cryptographic mechanisms for wireless device identification and for access control that exchange secrets via encrypted channels are used in some prior art methods in order to circumvent the problems in MAC address based identification/associations. However, these cryptographic approaches are limited by the inherent challenges in key distribution, management, revocation etc. and cannot scale effectively. Also, these cryptographic approaches are not accurate enough for many applications.

In other prior art approaches, static assets, including software fingerprinting or pre-distributed secure keys, are used as the means to establish whether multiple entities across wireless and wired networks point to the same physical device. However, these systems suffer from problems similar to the cryptographic methods in that they have insufficient inaccuracy and inefficiency. Existing fingerprint or hash-based identification mechanism require a priori seeding of the identification tokens and/or encryption keys. That is, the device has been pre-set with an embedded piece of software or data sequence that provides its unique identity to a central system. For example, a unique key is deployed in the device, or an algorithm capable of uniquely identifying the device is already deployed in the device in the form of software/firmware. Such a software program already deployed in the device establishes a secure communication to a server. The server may be a secure socket layer/transport layer security (SSL/TLS) client. Some information bootstrapping mechanism in the device is able to decode the uniform resource locator (URL) of the server to which this information must be sent. As such, these existing solutions require that the device be pre-configured in a manner that is known to the solution. Therefore, these solutions are only able to establish the identity of a newly entering wireless device in a monitored network when those devices have already been pre-configured for identification. Hence, these existing solutions fail to detect the network identity of any device that has not previously been seen. Consequently, these existing solutions are not pre-configured.

One feature of the method and apparatus for wireless network host to client association of the present teaching is that it does require any pre-configuration/seeding of the wireless devices. As a result, these methods and apparatus are applicable across all wireless devices of all different types. This generality allows for an open-ended support of the entire spectrum of heterogeneous devices without ever requiring any a priori seeding or pre-configuration.

One feature of the method and apparatus of wireless client and host association of the present teaching is that the association is deterministic. Some prior art approaches use probabilistic methods to identify devices based on their wireless signature. In contrast, the present teaching ensures all devices can be uniquely identified. As such, the fully deterministic methodology of the present teaching is more accurate, more efficient, and more certain at identifying client host associations.

As described herein, a fingerprinted data sequence is a pattern of bits that can be uniquely identified and distinguished from other fingerprinted data sequences. The term fingerprinting as used herein has a meaning similar to human fingerprinting where pattern can be uniquely linked to an individual. In some cases, mathematical transformations of the fingerprint may be used to represent the fingerprint for different applications. For example, a so-called signature of a fingerprint is a compressed version, or mathematical transformation, of the fingerprint that also uniquely represents the fingerprint.

In some embodiments of the present teaching, a sensor discovers a new network host, and the sensor sends data to that network host that contains a unique fingerprint. That fingerprint, or signature of that fingerprint, along with the identity of the network host being scanned with it, is sent to an application executing in the cloud by the sensor to record that the scan took place. If any wireless clients seen by that sensor, or any other sensors that are part of the same network environment, are observed receiving the uniquely fingerprinted data, the cloud application servers record the correlation and link the records in a database. This database is used to determine client host associations. When a client host association is made, a network topology is updated to include the new determined association of client and host. As such, a more accurate representation of the devices in the network is established.

In some embodiments, when a new network identification, typically an IP address, is granted by the underlying network management system, which is typically the DHCP server to which the wireless access points communicate, a new network host entry is created. A sensor maintains a proximate topology of device-host. If it doesn't detect the new host in that topology, the sensor first asks a software as a service (SaaS) solution that is maintaining a topology of the network if the new device exists in the whole topology. The new device, for example, may have been identified by another sensor that has already correlated the host with the new device. If the new device does not exist in the whole topology, then the sensor sends the unique fingerprint data.

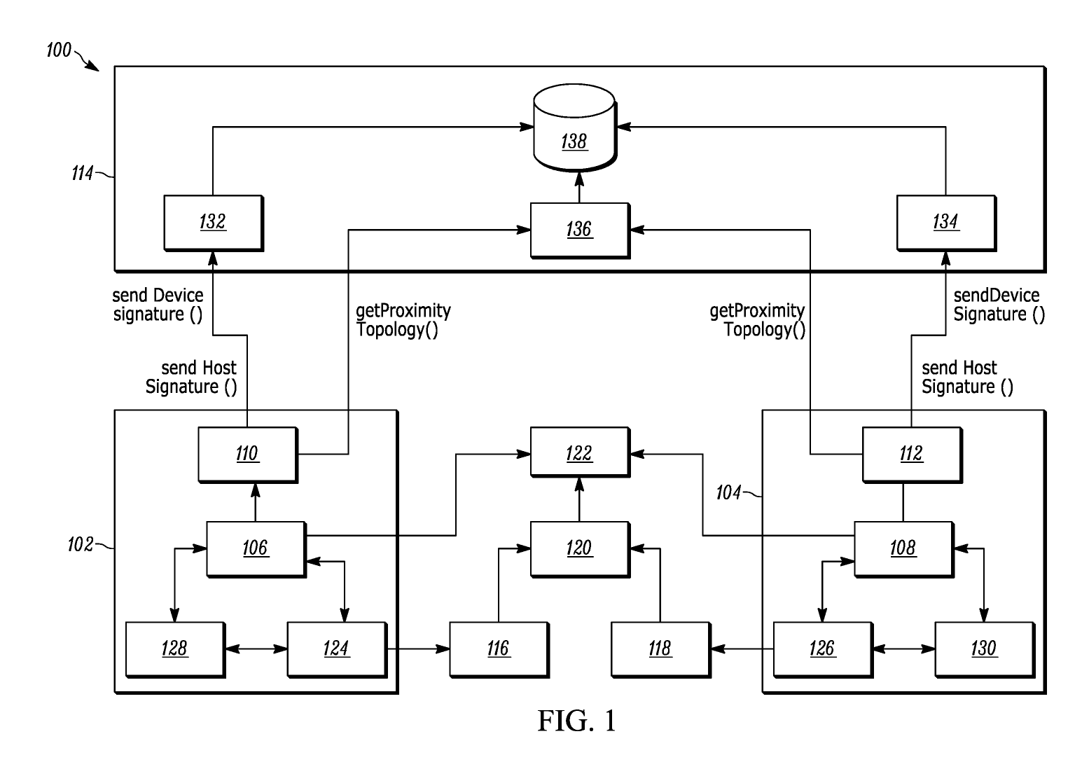

FIG. 1 illustrates a block diagram 100 of an embodiment of a method and apparatus that associates a wireless client to a network host of the present teaching. One or more distributed sensor devices 102, 104 are located in one or more monitored networks. The sensor devices 102, 104 may be any of a variety of known processing devices with wireless interfaces. The sensor devices 102, 104 include a sensor management module 106, 108 that includes a processor that executes the algorithms and/or steps of the method. The sensor devices 102, 104 include a wireless interface that resides in a communication module 110, 112 to allow the sensor to communicate with other wireless devices over wireless links using a variety of known communication protocols.

In general, a wireless device of the present teaching may take the form of any known device that transmits a wireless signal, for example, a wireless device may take the form of a tablet, laptop, cell phone, or a smart phone. The wireless device may be another specialized computing device, such as a gaming device, security device, or tracking device. For example, in some embodiments, the sensor devices 102, 104 can be devices manufactured by Pwnie Express, Boston, Mass., the assignee of the present application. These devices include PWN PHONE™, PWN PRO, PWN PAD™ and/or PWN PLUG.

One feature of the wireless client-to-network host association service of the present teaching is that it can incorporate device-to-device peer awareness across a set of networked sensors to build a time-varying tensor field of key sensor and other device positions and velocities information in a region of interest. See, for example, U.S. patent application Ser. No. 15/265,368 entitled “Reflective Network Device Position Identification”, U.S. patent application Ser. No. 15,285,733 entitled “Self-Managed Intelligent Network Devices that Protect and Monitor a Distributed”, U.S. patent application Ser. No. 15/617,103 entitled “Direction-Aware Device Location Services”, and U.S. patent application Ser. No. 15/618,716 entitled “Method and Apparatus for Wireless Device Location Determination Using Signal Strength”, which are all assigned to the assignee of the present application and which are incorporated herein by reference.

For example, U.S. patent application Ser. No. 15/265,368 discloses methods and apparatus for networked devices to share information for purposes of managing, identifying, and locating the devices using various methods. Using these and other known methods to share information amongst networked peer devices allows systems of the present teaching to achieve precise device location information more quickly and efficiently than prior art Wi-Fi and/or wireless positioning schemes.

The sensor devices 102, 104 monitor the wired and wireless traffic in a network. The sensor devices 102, 104 are connected to a client/host association module 114 that runs a client/host association software application(s) that performs some of the steps of the methods of the present teaching, including device-to-host correlation that is based on information sent to the client/host association module 114 by the sensor devices 102, 104. The client/host association software application(s) may be deployed as a remote service(s) hosted on a cloud. The cloud may comprise a public or a private data center, which can be an on premise data center or can be a remotely located data center. The software is agnostic to the underlying infrastructure of the cloud and independent of the provider of the cloud platform. The sensor devices 102, 104 are connected to the client/host association module 114 through a variety of methods, including, for example, a direct wireless link, a public Internet connection, a virtual private network (VPN) connection or numerous other methods. In some embodiments, the client/host association module 114 may be a software-as-a-service solution running on a cloud infrastructure. In some embodiments, the client host association module may reside in one or more sensor device 102, 104.

The sensor devices 102, 104 monitor wireless devices 116, 118 on a network that are connected to a wireless access point 120. The wireless access point 120 is connected to a network management module 122 that provides network host addressing and management services. In some embodiments, the network management module 122 runs DHCP, that dynamically assigns IP addresses to clients and assigns identifiers to network hosts.

The sensor devices 102, 104 include a wireless traffic analysis module 124, 126 that runs a process to monitor wireless traffic from wireless devices such as devices 116, 118. The wireless traffic analysis module 124, 126 is connected to a wireless scan module 128, 130. The wireless scan module 128, 130 and the wireless traffic module 124, 126 are managed and coordinated by the sensor management module 106, 108. The wireless scan module 128, 130 and/or the wireless traffic module 124, 126 detect when devices 116, 118 enter the network by detecting the wireless signal from the devices 116, 118. If the sensors 102, 104 determine a device 116, 118 is a new device, the sensor 102, 104 generates a uniquely fingerprinted data sequence that is sent to the new device 116, 118. The sensor management module 106, 108 connects to the network management module 122 and to the communication module 110, 112 of the sensor device 102, 104. The network management module 122 provides network host identification information to the sensor management module 106, 108. In various embodiments, sensor devices may be proximate to one or more wireless devices, and multiple sensor devices may be proximate to the same wireless device. Thus, one or more sensors may detect one or more wireless device. Multiple sensors may detect the same device.

The client/host association module 114 includes host device mapping modules 132, 134 and a network topology management module 136 that connect to the communication modules 110, 112 in the sensors 102, 104. The host device mapping modules 132, 134 connect to a database system 138. In some embodiments, the database system 138 may be a graph-based database system. In some embodiments, the topology is stored as a combination of a linear list and a 2-D matrix, or a linked list of linked lists. Various embodiments of methods and apparatus use a variety of known ways of efficiently storing the topological data.

The communication modules 110, 112 send wireless device signatures determined by the sensor management module 106, 108, which are based on generated uniquely fingerprinted data sequences, to the host device mapper module 132, 134. The sensor devices 102, 104 receive topology information from the network topology management module 136. The topology information is updated by the client/host association module based on information received from the sensors 102, 104 about the devices 116, 118.

In a monitored network environment, the sensor devices 102, 104 are aware of the known network hosts based on their existing records in the client/host association module 114. These records may include records of respective correlated wireless devices. The client/host association module 114 shares the known topology of the network with the sensor devices 102, 104. In various embodiments, the client/host association module 114 shares either the entire network topology or the relevant segment of the network topology with respect to the position of the sensor in the network. In this way, a sensor device 102, 104 has a comprehensive and accurate picture of the hosts in the proximity to the sensor 102, 104. Various algorithms may be used to decide on the most efficient segmentation of a sensor's proximate topology from the entire topology. In some embodiments, the segmentation algorithm also determines topology segmentations for each sensor that vary over time as the network topology evolves, based on the updated network topology.

In various embodiments, the client/host association module 114 is a conceptual abstraction and, as such, the client/host association module may not reside in one single physical/virtual/cloud Operating System instance, or even a cluster of such localized instances. It can be a multi-layered distributed stack. It an also be delocalized to ensure minimum latency and/or efficiency.

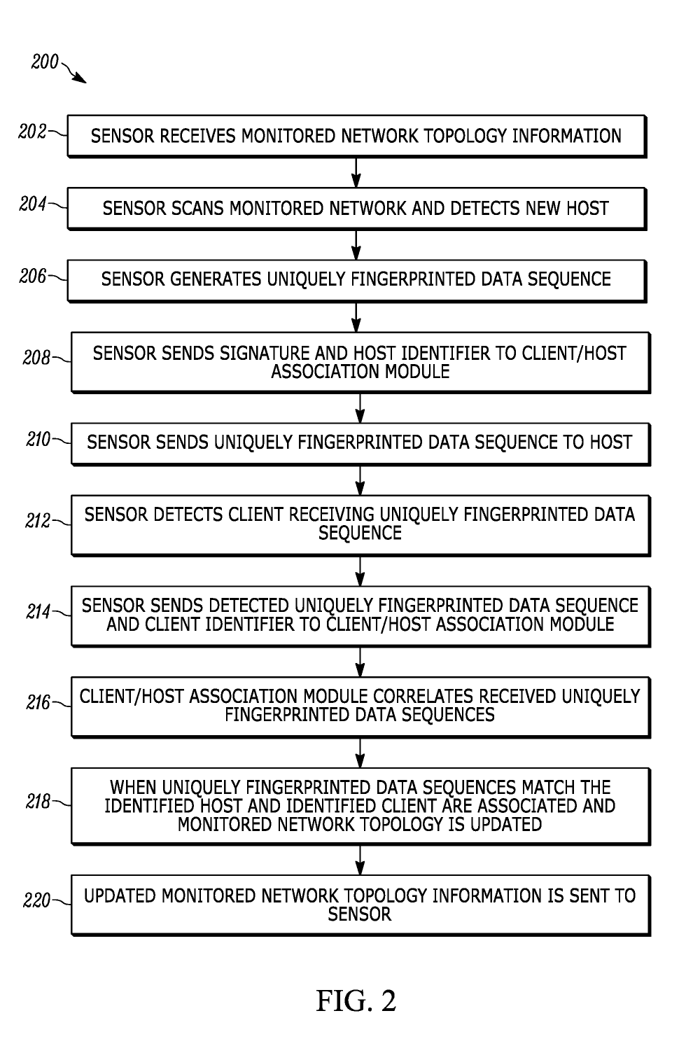

FIG. 2 illustrates a process flow diagram 200 of an embodiment of a method and apparatus for client/host association according to the present teaching. In step one 202, a sensor device receives monitored network topology information. The monitored network topology information may be full network topology information, or may be partial topology information that is limited to a particular segment of the network to which the sensor device is proximate. The monitored network topology information may be provided by a network topology manager in the client/host association process module of the present teaching. The monitored network topology information may also be generated by the sensor device based on information acquired from the network by the sensor.

In step two 204 of the method, the sensor device scans a monitored network. The network scan may be implemented by a wireless traffic analysis module that captures and analyzes all the wireless device traffic in the monitored network environment. The wireless traffic analysis may monitor any or all of the wireless signal strength, frequency, modulation format, communications protocols, data, control packets and other information about the wireless signals in the monitored network. The wireless network scan can determine network access points and connected network hosts identifiers such as SSID, and can scan a variety of network WiFi channels, and various communications protocols including 802.11 protocols. The wireless network scan can determine TCP/IP network information, including IP address, hostname, etc. As a result of the scan and based on the known monitored network topology information derived in step one 202, the sensor can determine if a new host has entered the monitored network. When a new host is identified, the method moves to step three 206. In step three 206, the sensor generates a uniquely fingerprinted data sequence. This uniquely fingerprinted data sequence is linked to the new host, and is unique to that linked host.

In some embodiments, a sensor detects a new network host from the network management system when it becomes aware of a wireless device. The sensor can detect data being sent to that device by scanning and/or monitoring wireless traffic. In these embodiments, the network host detection follows a different pathway in the system which carries no identity or indication of the actual underlying device.

In step four 208, the sensor sends a signature of the uniquely fingerprinted data sequence together with the host identifier information of the linked host to the client/host association module. The host identifier information may be derived by the sensor from a client/server protocol module running DHCP that resides in the monitored network, or from the wireless host. In some embodiments, the host identifier information is the scanned host's network identity, i.e. IP address, hostname, etc. For example, if the fingerprint value were represented as Va and host identifier information represented by Nk, the client/host association module now contains a record of mapping between Va and Nk.

In step five 210, the sensor sends the uniquely fingerprinted data sequence to the newly discovered host. In step six 212, a sensor detects a client device receiving a uniquely fingerprinted data sequence. The sensor may derive the client identifier information from a network host addressing and management system running DHCP that resides in the monitored network, or from the wireless client. The sensor that detects the uniquely fingerprinted data sequence and the client identification information can be the same sensor that sent the uniquely fingerprinted data sequence that is linked to the host, or in various other embodiments it may be a different sensor device.

In step seven 214, the sensor or sensors that detect the uniquely fingerprinted data sequence and the client identification information send this information to the client/host association module. Thus, the client/host association module has a signature of uniquely fingerprinted data sequence that is linked to a host, and a uniquely fingerprinted data sequence that is linked to a client. In step eight 216 of the method 200, the signatures of the uniquely fingerprinted data sequences are correlated to determine if they are the same, and, if so, in step nine 218, the client and host are associated and the network topology is updated. In step ten 220, the updated topology information is sent to the sensor.

In some embodiments, steps one 202 through step seven 214 of the method 200 are run on various sensor devices connected to a single client/host association module. The client/host association module is continuously receiving uniquely fingerprinted data sequences that are linked to various client and host identifiers. For example, a network host Nk is detected by sensor Si. Si may verify this is a new host device by reaching back to the client/host association module to establish if that host has already been identified and correlated by some other sensor Sj with a similar degree of topological affinity with the network segment under observation by the sensor Si. Upon verification that the network host is new, sensor Si then generates an unique sequence of data with a pre-defined normalized format F, computes and records a unique fingerprint for that data, sends the data to the network host Nk and sends the scanned host's network identity (IP address, hostname etc.) and the associated data fingerprint to the client/host association module. If the fingerprint value were Va, the client/host association module now contains a record of mapping between fingerprint value Va and network host Nk. That is, unique fingerprint value Va is linked to network host identifier value Nk.

Then, wireless device Dm is observed by a sensor Sk to receive a sequence of data in the pre-defined normalized format F. Then, sensor Sk computes the fingerprint for that data using the same algorithm that was used by sensor Si. For the device Dm the fingerprint for the observed data sequence is Vb. The sensor Sk then sends to the client/host association module the fact that wireless device Dm has received a data sequence uniquely identified with the fingerprint Vb. For the device Dm, the fingerprint for the observed data sequence is Vb. The sensor Sk then sends to the client/host association module the fact that wireless device Dm has received a data sequence uniquely identified with the fingerprint Vb.

Thus, the client/host association module receives a stream of such records of associations: Nk->Va and Dm->Vb whenever sensors are deployed in a new network environment to be monitored. If Va=Vb, the client/host association module unambiguously establishes that network host Nk and wireless device Dm are the same underlying physical device and, as a consequence, equates the network host Nk with the wireless device Dm in its monitored network topology.

In cases in which a new environment is being monitored, until a steady state is reached, that is, until all hosts have been scanned, the monitored network topology will remain partially complete. However, once the steady state is reached, the topology will be complete and there will be accurate and unambiguous association between network hosts and wireless devices. In this steady state of the monitored network, if a new device joins in and participates as a network host, then method steps one 202 through ten 220 are repeated, and as a result, the topology will expand to incorporate the new device and its corresponding representation as a network host.

In some embodiments, the data linking signatures of uniquely fingerprinted sequences linked to clients or hosts is stored in a database. In general, no association is required to be maintained in the database in the client/host association module between the data and the sensor that provided the data. Correlations are performed on various pairs of signatures of uniquely fingerprinted data sequences linked to one of various clients and one of various hosts. When the correlation results in a match, the particular client and host that are linked to the matching uniquely fingerprinted data sequences are associated, and updates are then made to the network topology.

Various embodiments of the method use various fingerprinting algorithms. In some embodiments, a Rolling Hash, or Rabin's algorithm with collision probability fully controllable, is used. The collision probability is the chance two different data blocks generate same signature. These embodiments are fast to compute, but offer but no protection against malicious attacks. Some embodiments use cryptographic hash functions like secure hash algorithm 3 (SHA-3) that provide protection against attacks, but take longer to compute. Some embodiments use SHA3-256 which offers reasonable computation time and full security for all practical purposes.

In general, no hashing or encryption is required to generate a unique fingerprint. Instead, a unique identifier generator, time-signature generator, or random generator can be needed. Thus, the encryption is used to provide security. More specifically, usage of encryption/hashing in the method and apparatus of the present teaching is simply to ensure that any eavesdropping device cannot decrypt/decode/playback the guaranteed unique data being sent to the wireless devices that the sensors recognize. Thus the methodology of the present teaching doesn't depend on any encryption or hashing mechanisms, but instead leverages existing encryption or hashing mechanisms to protect against malicious intrusions/eavesdropping.

In some embodiments of the method 200, if while scanning a network in step two 204, a sensor Si detects a new network host Nk which is not identifiable in the local copy of the full or partial topology information available to the sensor, the sensor reaches back to the client/host association module to establish if that host has already been identified and correlated by some other sensor Sj with a similar degree of topological affinity with the network segment under observation by the sensor Si. If yes, then sensor Si updates its local copy of the topology to accommodate this new network host Nk. A uniquely fingerprinted data sequence is not generated, and the sensor continues to scan for a new host.

One feature of the updated monitored network topology of the present teaching is that the comprehensive, deterministic and accurate topology can be used to improve the veracity of security solutions that rely on an accurate accounting of devices in a network. For example, in cases where multiple different types of assets are detected by multiple sensors to unambiguously establish that they are the same physical device, the threat vector analysis is improved as well as providing improved unification and security alerts. Referring to the earlier example, if Va=Vb, and the wireless monitoring solution detects a vulnerability in the wireless device Dm being exploited, then when the client/host association module becomes aware of the exploitation, it can refer to the comprehensive topology and quickly determine that the network host Nk is under risk. Prompt actions can then be taken to notify, isolate and remediate the threats. From the identification of the threat, systems can further provide an action report relating to the threat. Systems can also further provide tracking of information security compliance regulations as part of a risk assessment based on the associations that are determined between clients and hosts by the method and apparatus of the present teaching.

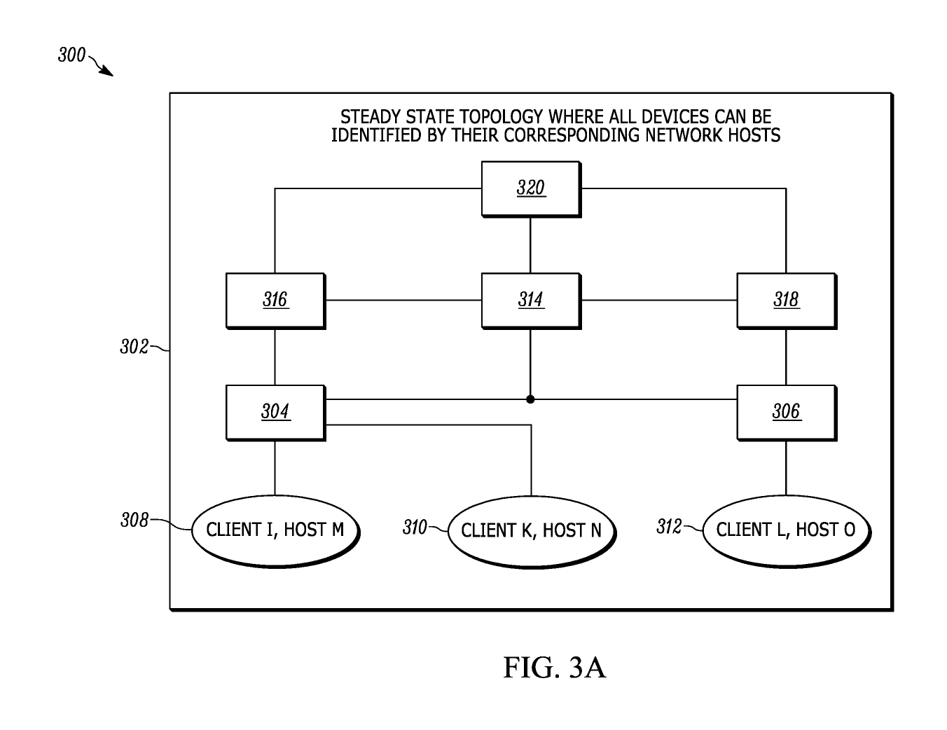

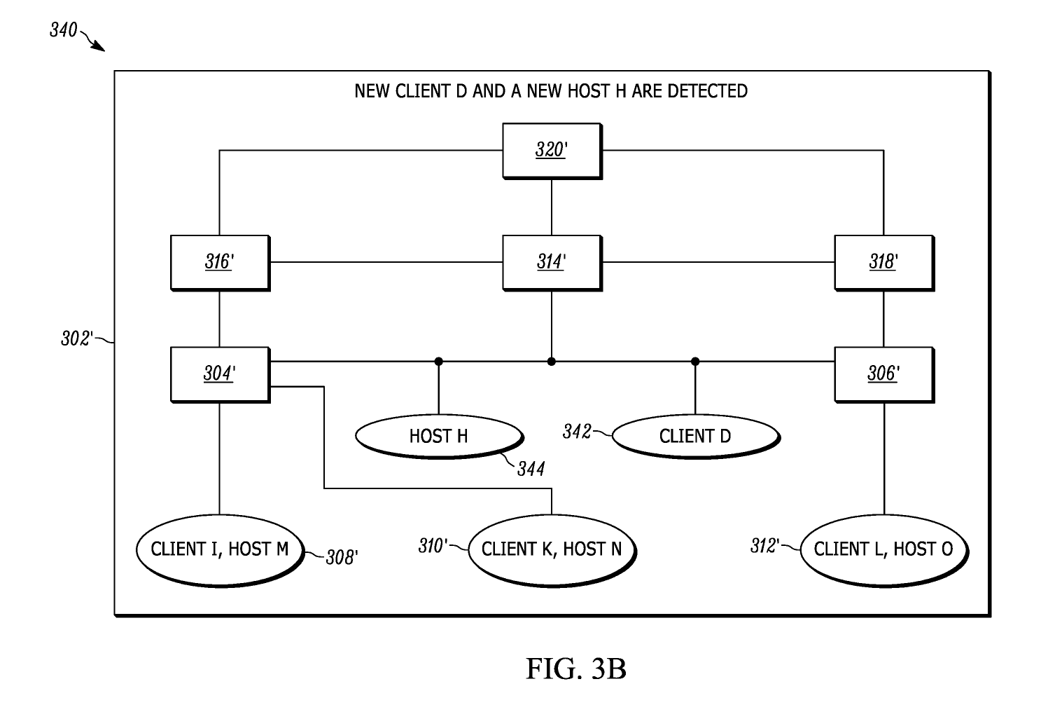

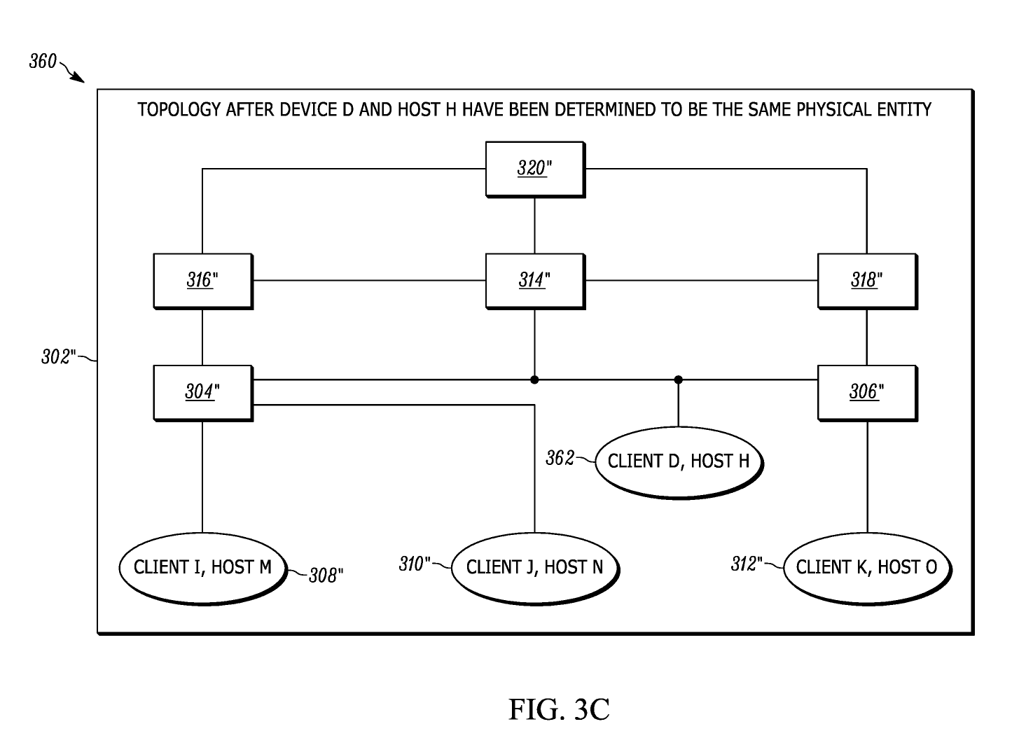

FIGS. 3A-C illustrate the topology updates resulting from the method and apparatus for client host association of the present teaching when a new wireless device enters a monitored network. FIG. 3A illustrates a steady state topology 300 of a monitored network of the present teaching. The steady state topology represents a state in which all known devices have been unequivocally associated with their network host identity. The monitored network 302 includes two wireless access points 304, 306. Two devices 308, 310 that include wireless clients Di and Dk that are associated with hosts m and n, are connected to one wireless access point 304. One device 312 that includes wireless client Dl that is associated with host o is connected to wireless access point 306. The wireless access points 304, 306 connect to a network host addressing and management module 314. In some embodiments, the module 314 implements DHCP protocol. The wireless access points 304, 306 and the network host addressing and management module 314 connect to gateway devices 316, 318. Gateway device 318 and the network host addressing and management module 314 connect to a domain name server 320.

FIG. 3B illustrates a topology 340 of a monitored network of the present teaching when a new, unassociated client 342 and host 344 enter the monitored network 302′ described in connection with FIG. 3A. The wireless access points 304′, 306′, wireless devices 308′, 310′, 312′, network host addressing and management module 314′, gateways 316′, 318′ and domain name server 320′ are described in connection with FIG. 3A. A sensor identifies the host 344 and sends uniquely fingerprinted data to that host 344. The client 342 then seen by that sensor, or any other proximate sensors, is observed receiving the uniquely fingerprinted data. Based on this information and based on the identity information about the client 342 and host 344, a processor is able to correlate the particular client 342 and host 344 and the client 342 and host 244 become associated and represented as such in an updated stored network topology of the monitored network.

FIG. 3C illustrates a topology 360 of a monitored network 302″ described in connection with FIG. 3A with the client and host association complete. The wireless access points 304″, 306″, wireless devices 308″, 310″, 312″, network host addressing and management module 314″, gateways 316″, 318″ and domain name server 320″ are described in connection with FIG. 3A. Client D and host HO are associated and represented as device 362.

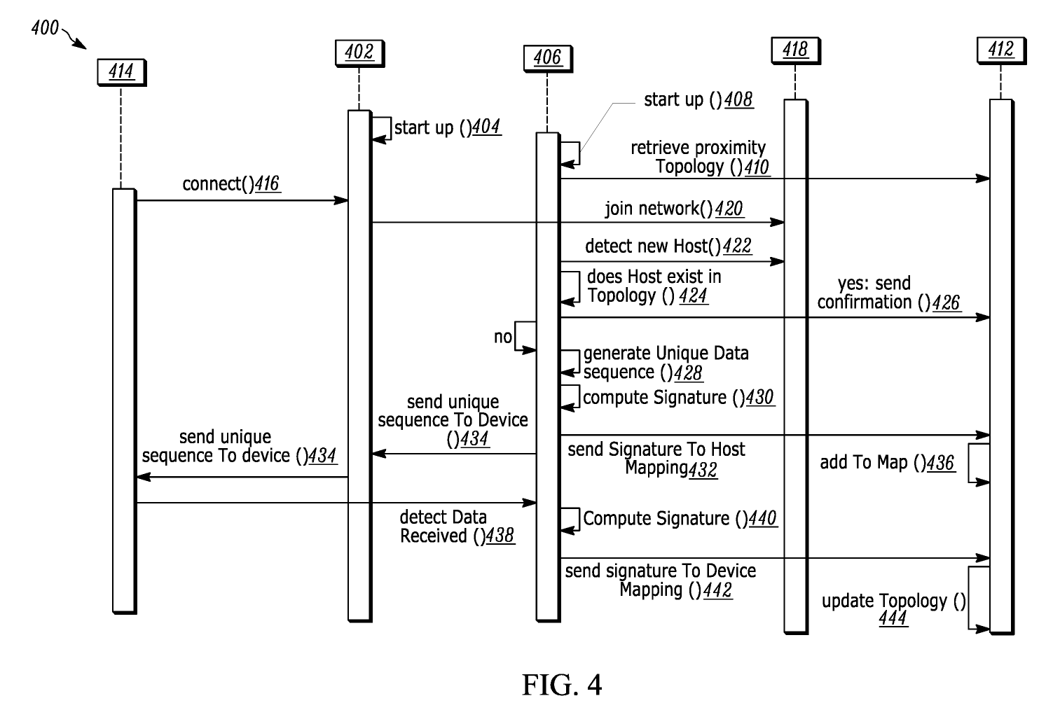

FIG. 4 illustrates a sequence diagram 400 of an embodiment of a method and apparatus for wireless client-to-wireless host association of the present teaching. A wireless access point 402 starts up 404. A sensor device 406 starts up 408 and retrieves 410 topology information from a client/host association module 412. The topology information may be a complete topology of a monitored network, or may be a partial topology segment proximate to the sensor 406. A wireless device 414 enters the monitored network topology, and connects 416 to the wireless access point 402. The wireless access point 402 connects to network management system 418 that includes a network host addressing and management capability. The wireless access point 402 joins 420 the wireless device 414 to the network. As a result, the wireless device obtains network identity (e.g. IP address, hostname, etc.). The sensor 406 detects the wireless device 414, and checks 422 with the network management system 418 to verify the identity. The sensor 406 determines 424 whether the detected host is already in the monitored network topology. If yes, the sensor 406 sends confirmation 426 of the host to the client/host association module 412. If no, the sensor 406 generates 428 a uniquely formatted data sequence, and computes 430 a signature of that sequence.

The signature and network identifier information about the host is sent 432 to the client/host association module 412. The uniquely formatted data sequence is sent 434 to the wireless device 414 via the access point 402. The signature and network identifier information is added 436 to a map by the client/host association module 412. The sensor 406, which can be the same sensor or a different sensor, detects 438 that the wireless device 414 received a uniquely identified data sequence. The sensor computes 440 a signature of that sequence. The sensor sends 442 the signature and device identifier information to the client/host association module 412. The client/host association module 412 stores the signatures and identifiers in a database. The client/host association module 412 correlates signatures, and associates devices with matching signatures. Updates 444 to the monitored network topology are made when new associated clients and hosts are determined.

Some embodiments of the client/host association module of the present teaching operate on an embedded software module in the sensor devices. The software module generates the associations. The associations generated by the embedded software module may be stored and utilized by other software within the device, and/or the information may be sent to a remote server or database that may act as a network management system and/or the information may be provided to a cloud-based service or application that uses the information to perform other tasks based on the associations. The tasks may include various security and compliance monitoring tasks.

Some embodiments of the client/host association module of the present teaching utilize centralized computation and association in a SaaS stack, which can be in the cloud or can be on-premise. The sensors are then simply responsible for detection and subsequent sending of information to the SaaS solution. In these embodiments, sensors do not generate the association. However the sensors can store the association for the proximate topology.

The terms “cloud”, and “cloud networking” as used herein includes services and networks that run over the public internet and work over any physical communications infrastructure, including wired or wireless infrastructures that may be privately or publicly owned, used and operated. The term “cloud” as used herein also includes so-called “private clouds” networking and services that run similarly over a private or proprietary infrastructure.

### EQUIVALENTS

While the Applicant's teaching is described in conjunction with various embodiments, it is not intended that the Applicant's teaching be limited to such embodiments. On the contrary, the Applicant's teaching encompass various alternatives, modifications, and equivalents, as will be appreciated by those of skill in the art, which may be made therein without departing from the spirit and scope of the teaching.

What is claimed is:

1. A method of wireless device association, the method comprising:
a) detecting a wireless signal from a first wireless device by wirelessly scanning a monitored network with a sensor device;
b) generating a first fingerprinted data sequence and a first signature of the first fingerprinted data sequence;
c) wirelessly sending the first fingerprinted data sequence to the first wireless device;
d) detecting a second wireless signal from a second wireless device and receiving a second fingerprinted data sequence;
e) generating a second signature from the received second fingerprinted data sequence; and
f) correlating the first signature of the first fingerprinted data sequence and second signature of the second fingerprinted data sequence to determine an association between the first and second wireless device.

2. The method of wireless device association of claim 1 wherein the first wireless device is a host device.

3. The method of wireless device association of claim 1 wherein the first and second wireless device are the same device.

4. The method of wireless device association of claim 1 wherein the sensor device comprises a security device.

5. The method of wireless device association of claim 1 wherein the sensor device comprises a tablet device.

6. The method of wireless device association of claim 1 wherein correlating the first and second signature comprises correlating with a software as a service platform executing on a cloud.

7. The method of wireless device association of claim 1 wherein generating the first fingerprinted data sequence comprises generating the first fingerprinted data sequence using a rolling hash.

8. The method of wireless device association of claim 1 further comprising generating a network topology based on the association.

9. The method of wireless device association of claim 1 further comprising identifying a vulnerability exploitation of the second device based on the association.

10. A wireless device association apparatus comprising:
a) a sensor comprising:
i) a wireless traffic analyzer configured to detect a first wireless signal from a first wireless device;
ii) a wireless interface configured to send a first fingerprinted data sequence to the first wireless device and configured to detect a second fingerprinted data sequence received at a second wireless device; and
iii) a processor configured to correlate a first signature derived from the first fingerprinted data sequence and a second signature derived from the second fingerprinted data sequence to determine an association between the first and second wireless devices.

11. The wireless device association apparatus of claim 10 wherein the first wireless device comprises a host device.

12. The wireless device association apparatus of claim 10 wherein the first and second wireless device are the same device.

13. The wireless device association apparatus of claim 10 wherein the sensor comprises a security device.

14. The wireless device association apparatus of claim 10 wherein the sensor comprises a tablet device.

15. The wireless device association apparatus of claim 10 wherein the processor is located remotely from the wireless interface.

16. The wireless device association apparatus of claim 10 wherein the first fingerprinted data sequence performs a rolling hash.

17. The wireless device association apparatus of claim 10 wherein the sensor is configured to generate a network topology based on the association.

18. The wireless device association apparatus of claim 10 wherein the sensor is configured to identify a vulnerability exploitation of the second device based on the association.
